(19) United States
(12) Patent Application Publication
(10) Pub. No.: US 2011/0239505 A1
(43) Pub. Date: Oct. 6, 2011

(54) Multi-panel foamboard displays

(76) Inventor: Steven Fink, Stamford, CT (US)

(21) Appl. No.: 13/065,217

(22) Filed: Mar. 15, 2011

Related U.S. Application Data
(60) Provisional application No. 61/340,361, filed on Mar. 15, 2010.
(60) Provisional application No. 61/343,563, filed on Apr. 30, 2010.
(60) Provisional application No. 61/342,197, filed on Apr. 8, 2010.

(51) Int. Cl. G09F 15/00

(52) U.S. Cl. 40/606.15

(57) ABSTRACT

A multi-panel display has at least two foamboard panels with a foam core and outer layers, and a web hinge connecting adjacent foamboard panels. The web hinge is secured to the respective edges of the adjacent panels with a web extending therebetween, the web offset from the outer layers of the panels to adapt the panels for bidirectional folding movement. One web hinge is a strip of flexible sheet material having marginal edges, received in slits in the foam cores of adjacent panels. The edges may be secured at time of manufacture or inserted by the user to connect selected panels. The web hinges may have an I-shape secured to edges of adjacent panels, or may have U-shaped flanges embracing edges of adjacent panels, with a web connecting the flanges.

### RELATED APPLICATIONS

This application claims priority to my U.S. Provisional Application Ser. No. 61/340,361 filed Mar. 15, 2010 and my U.S. Non-Provisional Application Ser. No. 61/343,563 filed Apr. 30, 2010.

### FIELD OF THE INVENTION

The invention herein relates to multi-panel foamboard displays with the panels hinged for selective side display orientation.

### BACKGROUND OF THE INVENTION

Foamboard is desirable for displaying information, because it is substantially stiff and yet lightweight. Foamboard is generally comprised of a foam core and paper or thin paperboard outer layers adhered to the foam core. The front surface of a front outer layer may be coated, e.g. by a clay-based coating, to provide a smooth surface receptive to inks so that information may be written on the surface for display. The front surface of the front outer layer may also be provided in a color, if desired, and the color may be achieved with pigmented or dyed coatings.

Three-panel foamboard for self standing displays has been provided. Each of the three panels has the construction generally described above, and the first outer layer is continuous to form respective hinges connecting the three panels. This permits the front surfaces of the two side panels to fold inwardly toward the front surface of the center panel, such that the three panels may be self supporting on a flat surface such as a table.

However, by utilizing the paperboard layer forming the front surfaces of the three panels as the hinge structure between the panels, the side panels cannot be folded away from the center panel and toward the back surface of the center panel. Therefore, the back surface of all of the panels is not used as an alternate display surface and the outer paperboard layer of the back surfaces generally provided without coating or color, and provides a utilitarian coverage of the foam core. Additionally, because the side panels can only be folded inwardly with respect to the front surface of the center panel, the structure is limited to three panels with the side panels having about one-half the width of the center panel, so that the display can be folded flat.

The prior three panel foamboard is also difficult for merchants to stock and sell, and is therefore provided in limited colors. A user cannot obtain and assemble a multi-panel display, and in particular cannot do so in a choice of number of panels and colors. Therefore, overcoming the drawbacks of prior art foamboard would be a welcome advance in the art.

### SUMMARY OF THE INVENTION

It is a principal object of the invention herein to provide a multi-panel foamboard that may be oriented for using either the front or back surfaces of the center and side panels as a display surfaces.

It is an additional object of the invention herein to provide a multi-panel foamboard with more than three panels.

Another object of the invention herein is to provide a multi-panel foamboard which folds easily to a flat condition.

It is a further object of the invention herein to provide a multi-panel foamboard for display surfaces which has a durable hinge connection between adjacent ones of the multiple panels.

It is also an object of the invention to provide a multi-panel foamboard wherein the panels are of substantially the same width.

It is yet another an object of the invention to provide multiple foamboard panels and a hinge structure that permits connection of a selectable number of the multiple panels to form a multi-panel foamboard display.

It is a still further object of the invention to provide for assembling a multi-panel foamboard and display in a selected number of panels and colors, to disassemble the multi-panel display for storage and future assembly and use.

In carrying out the invention herein, at least two foamboard panels are connected by a flexible web hinge. Each foamboard panel has a foam core and a paper, paperboard or other outer layers suitable for display purposes on at least one and preferably two sides of the foam core. The web hinge is provided by at least one web secured to and extending between adjacent edges of the two foamboard panels, with the web positioned offset from the outer layers and preferably approximately evenly spaced from the two outer layers of the foamboard panels. The web has a width of at least the thickness of the foamboard panels, so that the foamboard panels may be folded to lie adjacent each other for storage and transportation.

In certain aspects of the invention, three foamboard panels are respectively connected by flexible web hinges. The two side panels may be one-half or less of the width of the center panel, so that both side panels will fold over and lie adjacent the front panel. The two side panels may also have substantially same width as the front panel, such that one side panel may fold over and lie adjacent one side of the center panel and the other side panel may fold over and lie adjacent the second side of the center panel.

In additional aspects of the invention, the front and back surface layers of the foamboard panels are both suitable for display purposes. The first and second outer layers may be paper or paperboard, and the paper or paperboard may be coated to enhance its smoothness, appearance and receptivity to inks and dyes for imparting information and indicia thereto. Both surfaces of the first and second outer layers may be white, may be colored, or may be one white and one colored.

In other aspects of the invention, the web hinge is a continuous polymer strip having marginal edges respectively inserted into and secured in the foam cores of adjacent foamboard panels, with the exposed portion of the polymer strip forming an exposed web between the foamboard panels. Slits may be formed in the foam core to receive the marginal edges. The marginal edges of the polymer strip may be secured in the foam cores by heat fusing, by adhesive, by solvent or ultrasonic welding, or by other suitable means. The web hinge may also be other flexible sheet material. The web hinge may be continuous or discontinuous along the edges of adjacent foamboard panels.

In an additional aspect, the web hinge is insertable by an end user to connect two selected foamboard panels. Multiple web hinges and multiple panels may be connected to form a multi-panel display. The inserted may be held in the foam core by friction or portions of the web hinge may have a tack adhesive on the inserted surfaces to better retain the web hinge.

In another aspect, the web hinge has flat flanges, wherein the hinge has an I-shape cross-section with the web extending between the flat flanges. The flat flanges are secured to the edges of the adjacent foamboard panels by heat fusing, by adhesive, by solvent or ultrasonic welding, or by other suitable means.

In a further aspect the web hinge has U-shaped flanges with the web extending therebetween, and the U-shaped flanges respectively embrace the marginal edges of adjacent foamboard panels. The legs of the U-shaped flanges are preferably deployed over the outer layers of the foamboard panels and may be secured by friction and/or adhesive. The flanges may also be secured to the foam core under the outer layers at the time of manufacture of a multi-panel display. This permits assembly and disassembly of selected panels by an end user.

In a yet further aspect of the invention, a web hinge with U-shaped flanges is fitted onto the marginal edge of adjacent foamboard panels, such that any selected number of foamboard panels may be connected to form a multi-panel display. The U-shaped flanges may be removable, so that the number and color of foamboard panels may be selected by the end user, and so that the number of foamboard panels may be reduced or the order of the foamboard panels may be rearranged. The U-shaped flanges may be retained by friction, by tack adhesive, or both, to permit disassembly and reassembly, or may be secured by permanent adhesive.

Other and more specific objects and features of the invention will in part appear in the following detailed description of the invention and the claims, taken together with the drawings.

### BRIEF DESCRIPTION OF THE DRAWINGS

FIG. 1 is a perspective view of a three-panel foamboard display according to the invention herein;

FIG. 2 is a perspective fragmentary view of two adjacent foamboard panels of the three-panel foamboard display of FIG. 1, showing a hinge structure thereof;

FIG. 3 is a fragmentary top view of two adjacent panels and the connecting hinge of the three-panel foamboard display of FIG. 1, folded in a first direction;

FIG. 4 is a fragmentary top view of two adjacent panels and the connecting hinge of the three-panel foamboard display of FIG. 1, folded in a second direction;

FIG. 4A is a fragmentary sectional view of an alternative web hinge connecting adjacent panels of the foamboard display of FIG. 1;

FIG. 5 is an end view of the three-panel foamboard display of FIG. 1, shown folded to a storage position;

FIG. 6 is a perspective view of another three-panel foamboard display according to the invention herein;

FIG. 7 is an end view of the three-panel foamboard display of FIG. 6, shown folded to a closed condition;

FIG. 8 is a perspective view of another multi-panel foamboard display according to the invention herein;

FIG. 9 is an end view of the multi-panel foamboard display of FIG. 8, shown folded to a closed condition;

FIG. 10 is a top view, partially cut away, of another multi-panel foamboard display according to the invention herein;

FIG. 11 is a perspective view, partially cut away, of the web hinge of the multi-panel foamboard display of FIG. 10;

FIG. 12 is a top view of another multi-panel foamboard display according to the invention herein;

FIG. 13 is a perspective view, partially cut away, of the web hinge of the multi-panel foamboard display of FIG. 12;

FIG. 14 is a front elevation view, partially exploded, of another multi-panel foamboard display in which the multiple foamboard panels are selectively connected by a web hinge; and

FIG. 15 is a perspective view of a web hinge of the multi-panel foamboard display of FIG. 14.

The same reference numerals refer to the same elements throughout various figures.

### DETAILED DESCRIPTION OF THE INVENTION

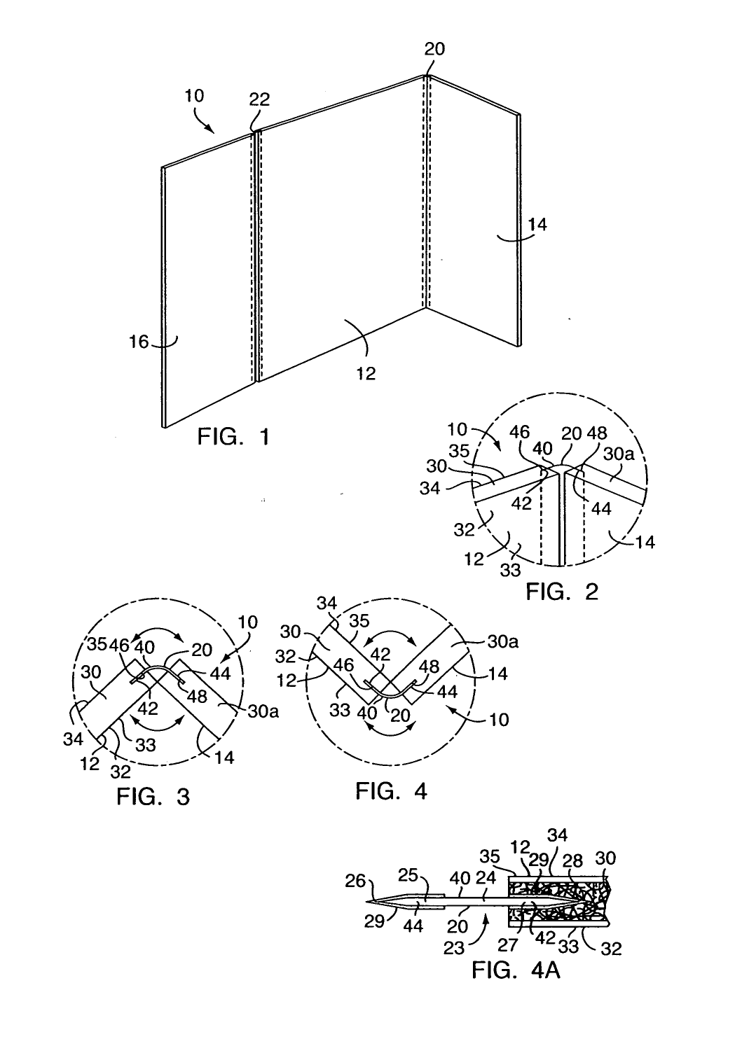

The invention relates to multi-panel foamboard displays, including the three-panel foamboard display 10 shown in FIG. 1. It generally comprises a center foamboard panel 12, foamboard side panels 14, 16, and web hinges 20 and 22 respectively connecting the side panels 14, 16 to the center panel 12.

The center panel 12 has a foam core 30, which may be extruded polystyrene or a similar substantially rigid lightweight foam material. The thickness of the foam core is selected appropriately for the size of the panel, and in a center panel having dimensions approximately 20 inches width and 30 inches height, the foam core may be about ⅛ to ½ inches thick and preferably slightly less than ⅜ inches thick. Those and other dimensions given for embodiments illustrated herein shall be considered illustrious of typical construction, but not limiting to the scope of the invention.

The center panel 12 has first and second outer layers 32 and 34 adhered to the opposite sides of the foam core 30, as is well known in the art. The outer layers 32, 34 are typically paper or light weight paperboard, but may be other sheet material suitable for use as a display surface. The outer layers 32, 34 may be coated on their outer surfaces 33, 35 to improve smoothness and receptivity to ink. The coating may be clay based, and it may be white or colored. The outer surfaces 33, 35 may both be white, may be one white and one colored, or may both be colored. The outer layers 32 and 34 preferably have substantially similar characteristics, i.e. such that both outer surfaces 33 and 35 are suitable for use as display surfaces. The thickness of the center panel is typically ⅜ inches, including the foam core and outer layers.

The side panels 14, 16 have similar construction and characteristics to the center panel 12. In the three-panel foamboard display 10, the side panels 14 and 16 each have approximately one-half or less the width of the center panel 12.

The side panels 14, 16 are connected to the center panel 12 by the web hinge 20 having a flexible web 40. With particular reference to FIGS. 2-4, the web hinge 20 is a strip of flexible, tear resistant material, which is preferably a flexible polymer. The web hinge 20 has marginal edges 42, 44 extending from the central web 40 with marginal edge 42 being received in a slit 46 formed in the foam core 30 of center panel 12. The marginal edge 44 is similarly received in a slit 48 in the foam core 30a of the side panel 14. The marginal edges 42, 44 are secured in the slits 46, 48 by heat fusing, by adhesive, by solvent or ultrasonic welding, or by any other suitable means. The slits 46 and 48 are spaced from both outer layers and are preferably substantially centrally located across the thicknesses of the foam cores 30 and 30a. The width of the web 40 is at least as great as the thicknesses of the center panel 12 and side panel 14.

As noted above, the web hinges 20,22 may be secured between adjacent panels at the time of manufacture by heat fusing, adhesive or other suitable means. However, the web hinges may also be inserted by the end user. This permits the end user to select particular panels, e.g. by color and to prepare the display content for each panel prior to connecting adjacent panels.

To facilitate such connection, a web hinge 23 is shown in FIG. 4A. It has a center web 24 and marginal edges 25 and 27, which respectively have sharp edges 26 and 28 which facilitate insertion into the foam cores of adjacent panels. The inserting of the marginal edges creates slits in adjacent foam cores, in which the marginal edges are received and retained.

Although the marginal edges are retained by friction, the marginal edges are preferably coated with a tack adhesive. This permits the edges to be inserted but also helps to retain the marginal edges in the slits.

The display panels connected by web hinge 22 for transport and storage, or rearrangement or replacement of one or more panels, by removing the web hinge 22 from at least one of the adjacent panel. The web hinge 22 may be replaced in its slit to reassemble the display, at least for several times before the slit becomes worn and loose.

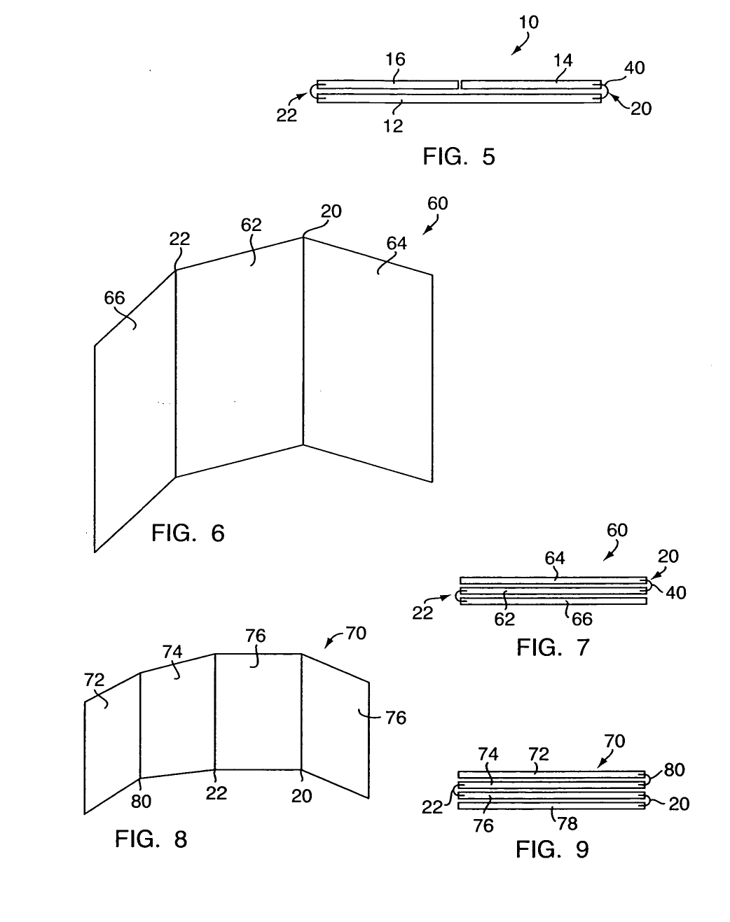

The other side panel 16 is similarly hingedly connected to the other edge of the center panel 12 by web hinge 22, which has the same structure, dimensions and characteristics as the web hinge 20. This permits the side panels 14 and 16 to fold in either direction with respect to the center panel 12, as shown for center panel 12 and side panel 14 in FIGS. 2-4. With reference to FIG. 5, the side panels 14, 16 may fold inwardly to lie adjacent the center panel 12, for packaging, transport or storage of the three-panel display 10.

With reference to FIG. 6, another multi-panel foamboard display 60 according to the invention herein is shown. It has a center panel 62 and side panels 64 and 66 of substantially the same dimensions as the center panel 62. The center panel 62, and side panels 64, 66 have substantially the same construction as the center panel 12 and side panels 14, 16 described above, except for the difference in the size relationship between the center panels and side panels. Similarly, the side panels 64, 66 are respectively connected to opposite edges of the center panel 62 by web hinges 20 and 22, having the same structure and in the same manner as described above. The multi-panel foamboard display 60 is also useable from either side, i.e. the side panel 64 and 66 fold bidirectionally with respect to the center panel 62, similarly to that shown in FIGS. 2-4.

As illustrated in FIG. 7, the multi-panel foamboard display 60 may be folded for packaging, storage and transportation by folding the side panel 64 to overlie one side of the center panel 62 and folding the side panel 66 to overlie the second side of the center panel 62. This is an advantage achieved by the bidirectional folding capability of the web hinge structure connecting the side panels 64, 66 and the center panel 62.

With respect to FIG. 8, another multi-panel foamboard display 70 is illustrated, having four panels 72, 74, 76 and 78. Each of the panels 72, 74, 76, and 78 may have structure similar to the panels 12, 14 and 16 described above, and the panel 72, 74, 76 and 78 may each have substantially the same height and width dimensions.

The panels 72, 74, 76 and 78 are respectively connected by web hinges 20, 22 and an additional web hinge 80 substantially similar thereto. Thus, as illustrated in FIG. 9, the multi-panel foamboard display 70 may be folded to a flat condition for packaging, storage or transportation with the panels stacked upon each other.

Web hinges 23 may also be used to connect the four panel display 70 with the benefits discussed above.

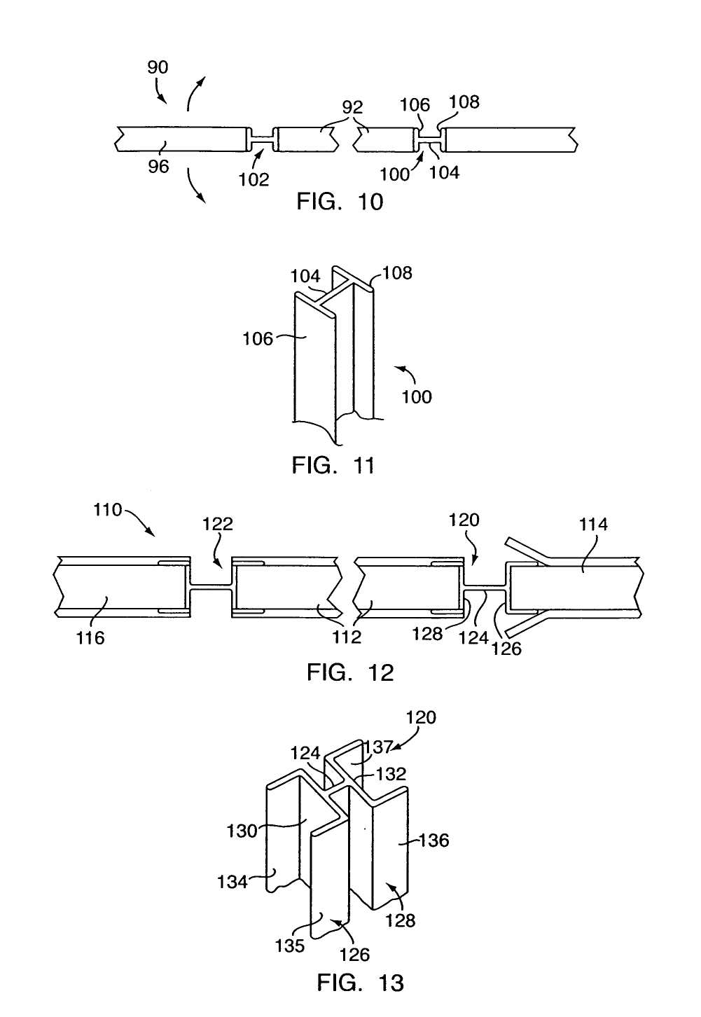

FIG. 10 illustrates another multi-panel foamboard display 90 according to the invention herein. It generally comprises a center panel 92 and side panels 94, 96, all having a similar construction to the panels 12, 14 and 16 described above. The panels 92 and 94 are connected by a web hinge 100, which is also shown in FIG. 11. Panels 92 and 96 are connected by a web hinge 102 of the same structure as hinge 100.

The web hinge 100 may be formed of a flexible polymer, and has a web 104 extending between two flat flanges 106 and 108. The flat flange 106 is secured to the edge 93 of side panel 92 by heat fusion, adhesive, solvent or ultrasonic welding, or any other suitable means, and flat flange 108 is similarly secured to the edge 95 of the side panel 94. The web 104 has a width of at least the thickness of the adjacent panels 92 and 94.

Therefore, the side panels 94 and 96 fold bidirectionally with respect to the center panel 92, and the side panels 94 and 96 may fold to lie adjacent the center panel 92 for packaging, transportation or storage in a manner similar to that shown in FIGS. 5, 7 and 9, depending on the number of panels and their relative dimensions.

FIG. 12 illustrates another multi-panel foamboard display 110 according to the invention herein and includes a center panel 112, and side panels 114 and 116. The side panels are connected to the center panels by web hinges 120, and 122, which are substantially the same construction, with web hinge 120 being shown in FIG. 13.

The web hinge 120 has a web 124 and two U-shaped flanges 126, 128 integrally formed therewith. The web is positioned centrally along bases 130, 132 of the U-shaped flanges 126, 128 and the legs 134, 135 and 136, 137 of the U-shaped flanges are spaced apart by the same distance as the thickness of the foam cores of the panels 112, 114 and 116.

If the panels of the foamboard display 110 are connected at the time of manufacture, the web hinge 120 is attached to the panels 112 and 114 by inserting the respective cores of those panels between the legs of the U-shaped flanges. The U-shaped flanges are adhered to the foam cores, such as by heat fusing, adhesives, sonic or ultrasonic welding or other suitable means to secure the U-shaped channels 126, 128 to the panels 92 and 94. The outer layers of the panels 112, 118 preferably overlie the legs of the U-shaped flanges as best seen in FIG. 12, so that the flanges are less visible in the assembled multi-panel foamboard display 120. The outer layers are also attached to the flanges of the hinge, preferably by adhesive in the case of the paper or paperboard surface layer. If the attachment is sufficiently secure, it is not necessary to otherwise attach the flanges to the foam core.

The side panel 116 is similarly attached to the center panel 112 by web hinge 122. The webs of web hinges 120, 122 are at least as wide as the thickness of the adjacent panels. This permits both bidirectional folding for display purposes and also folding the panels to lie adjacent each other for packaging, storage and transportation.

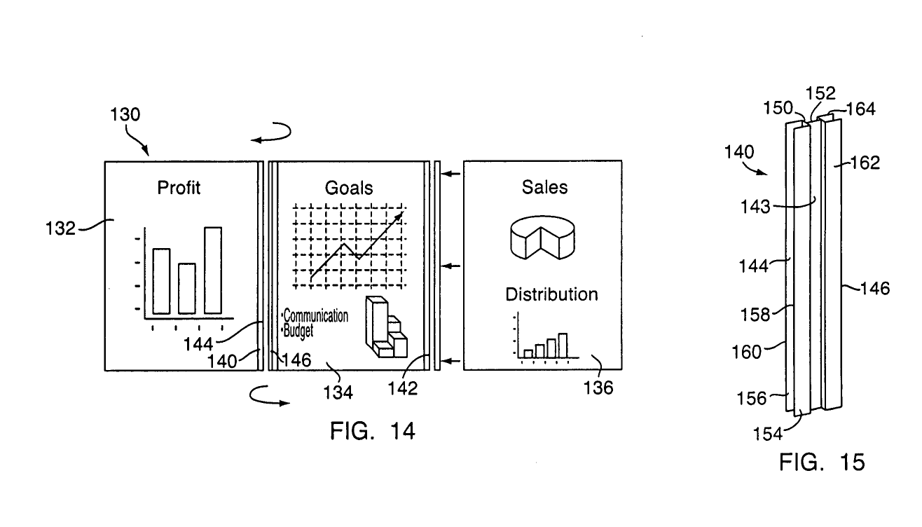

FIG. 14 illustrates another multi-panel foamboard display 130, having panels 132, 134 and 136. The multi-panel foamboard display 130 is characterized by web hinges 140, 142 that selectively connect selected ones of the multiple panels. In FIG. 14, panels 132 and 134 are connected by web hinge 140, and panel 136 is shown being selectively connected to panel 134 by web hinge 142.

Web hinge 140 is shown in FIG. 15. It has a web 143 connecting two opposed U-shaped flanges 144, 146 formed integrally therewith. The web 143 is positioned centrally along bases 150, 152 of the U-shaped flange 144, 146, and the bases 150, 152 have a width to accommodate the thickness of panels 132, 134, 136. The legs 154, 156 of U-shaped flange 144 converge from the base 150, and may be slightly concave with respect to each other to form edges 158, 160. The other U-shaped flange 146 has similar legs 162, 164, and the web hinge 140 is made of a resilient polymer that biases legs 154, 156 and legs 162, 164 together for clamping purposes.

With reference to FIG. 14, a marginal edge of panel 130 is received in U-shaped flange 144, and is gripped and held by the U-shaped flange 144. The marginal edge of panel 132 is similarly received in, gripped by and held in U-shaped flange 146, thereby connecting panels 130, 132 by web 143. The panels 130, 132 are bendable with respect to each other so that alternate display orientations may be selected and the panels 130, 132 may be folded flat for storage or transport. Panel 134 is shown being added to the multi-panel display by fitting web hinge 142 onto panel 132 and by fitting panel 134 to web hinge 142. More panels can be added using additional web hinges, as desired.

The inside surfaces of the legs 154, 156 and 162, 164 of the U-shaped flanges may be fitted with barbs or other friction configurations to make the connection of the panels secure. Tack adhesive may also be used inside the flanges for additional grip, with or without the barbs or other friction configurations. However, the barbs or friction configurations may also be of moderate strength, so that panels may be disconnected. This permits, for instance, the replacement of one panel with updated or otherwise different information, or selecting from multiple panels and connecting selected panels for varied presentations.

Accordingly, multi-panel foamboard displays have been described which admirably achieve the objects of the invention and advancement in the art. It will be appreciated that the foregoing description of various embodiments of the invention is illustrative only, and that changes may be made by those skilled in the art without departing from the spirit and the scope of the invention, which is limited only by the following claims.

I claim:

1. A multi-panel display comprising:
A) at least two foamboard panels each having a foam core and first and second outer layers respectively adhered to foam core; and
B) a web hinge connecting adjacent foamboard panels, the web hinge secured to the respective edges of the adjacent panels and having a web extending therebetween, the web being offset from the outer layers of the foamboard panels to adapt the foamboard panels for relative bidirectional folding movement.

2. A multi-panel display as defined in claim 1 wherein the web is substantially centrally disposed between the outer layers of the foamboard panels.

3. A multi-panel display as defined in claim 2 wherein the web has a width at least as great as the thickness of the foamboard panels.

4. A multi-panel display as defined in claim 1 wherein the web hinge is a strip of flexible sheet material having a web and marginal edges, and the marginal edges are respectively secured in slits in the foam cores of adjacent panels.

5. A multi-panel display as defined in claim 4 wherein the flexible sheet material is a polymer.

6. A multi-panel display as defined in claim 5 wherein at least one of the marginal edges of the web hinge is secured in the slit in the foam core by one of heat fusing, adhesive, solvent welding or ultrasonic welding.

7. A multi-panel display as defined in claim 5 wherein the marginal edges of the web hinge taper to a sharp side edge insertable into the foam core of an adjacent panel and forming a slit receiving the marginal edge.

8. A multi-panel display as defined in claim 7 wherein the marginal edges of the web hinge have tack adhesive thereon that permits insertion of the marginal edges into the foam core and assists in retaining the marginal edges with the slits.

9. A multi-panel display as defined in claim 1 wherein the web hinge has an I-shaped cross-sectional shape, with the web extending between two flat flanges, and the flat flanges are respectively secured to the edges of adjacent panels.

10. A multi-panel display as defined in claim 9 wherein the web is substantially centrally disposed between the outer layers of the foamboard panels.

11. A multi-panel display as defined in claim 10 wherein the web has a width at least as great as the thickness of the foamboard panels.

12. A multi-panel display as defined in claim 9 wherein the flat flanges have legs to form U-shaped flanges, and the U-shaped flanges embrace the foam cores of adjacent panels.

13. A multi-panel display as defined in claim 12 wherein the legs of the U-shaped flanges are secured to the foam cores of adjacent panels under the outer layers thereof.

14. A multi-panel display as defined in claim 9 wherein the flat flanges have legs to form a U-shaped flange, and the legs are biased toward each other to grip and hold the marginal edge of a foamboard panel.

15. A multi-panel display as defined in claim 14 wherein the U-shaped flanges releasably grip and hold adjacent panels, such that the multi-panel display may be assembled, disassembled and reassembled, and different panels may be substituted into the multi-panel display.

16. A multi-panel display as defined in claim 15 wherein the legs of the U-shaped flanges gripping a foamboard panel have tack adhesive applied thereto.
